(19) United States
(12) Patent Application Publication
(10) Pub. No.: US 2014/0051542 A1
(43) Pub. Date: Feb. 20, 2014

(54) PLANETARY GEAR TRAIN OF AUTOMATIC TRANSMISSION FOR VEHICLES

(71) Applicant: HYUNDAI MOTOR COMPANY, Seoul (KR)

(72) Inventors: Sang Bum Baek, Seoul (KR); Hyukjun Lee, Yongin-si (KR); Jongsool Park, Hwaseong-si (KR)

(73) Assignee: Hyundai Motor Company, Seoul (KR)

(21) Appl. No.: 13/714,257

(22) Filed: Dec. 13, 2012

(30) Foreign Application Priority Data
Aug. 17, 2012 (KR) 10-2012-0090319

(51) Int. Cl. F16H 3/44

(52) U.S. Cl. CPC F16H 3/44
USPC 475/284; 475/271

(57) ABSTRACT

A planetary gear train of an automatic transmission may include: an input shaft; an output shaft; a first planetary gear set including first, second, and third elements disposed on the input shaft with two elements selectively connected to the input shaft; a second planetary gear set including fourth, fifth, and sixth elements disposed on the output shaft with two elements selectively connected to the input shaft, two elements connected to two elements of the first planetary gear set, and one element directly connected to the output shaft; four transfer gears selectively meshing the fourth, fifth, and sixth elements with the input shaft and the first planetary gear set; and six friction members including four clutches variably connecting the first planetary gear set and the second planetary gear set to the input shaft and two brakes variably connecting selected elements to a transmission housing.

### CROSS-REFERENCE TO RELATED APPLICATION

The present application claims priority of Korean Patent Application Number 10-2012-0090319 filed Aug. 17, 2012, the entire contents of which application is incorporated herein for all purposes by this reference.

### BACKGROUND OF INVENTION

1. Field of Invention

The present invention relates to an automatic transmission for a vehicle. More particularly, the present invention relates to a planetary gear train of an automatic transmission for a vehicle that can improve power delivery performance and reduce fuel consumption.

2. Description of Related Art

Typically, a planetary gear train is realized by combining a plurality of planetary gear sets and friction members. It is well known that when a planetary gear train realizes a greater number of shift speeds, speed ratios of the planetary gear train can be more optimally designed, and therefore a vehicle can have economical fuel mileage and better performance. For that reason, the planetary gear train that is able to realize more shift speeds is under continuous investigation.

Though achieving the same number of speeds, the planetary gear train has a different operating mechanism according to a connection between rotation elements (i.e., sun gear, planet carrier, and ring gear). In addition, the planetary gear train has different features such a durability, power delivery efficiency, and size depend on the layout thereof. Therefore, designs for a combining structure of a gear train are also under continuous investigation.

In addition, the planetary gear train realizes a plurality of shift-speeds. However, another friction member must be operated after one friction member is released so as to shift to a neighboring shift-speed from a view of shift control. In addition, a step ratio between the neighboring shift-speeds should be controlled to be suitable according to the planetary gear train.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a planetary gear train of an automatic transmission for a vehicle having advantages of improving power delivery performance and reducing fuel consumption as a consequence of achieving eight forward speeds and two reverse speeds having excellent operating condition of frictional members and step ratios by combining two planetary gear sets, four externally meshing gears and six friction members.

A planetary gear train of an automatic transmission for a vehicle according to various aspects of the present invention may include: an input shaft receiving torque of an engine; an output shaft outputting changed torque; a first planetary gear set including first, second, and third rotation elements and disposed on the input shaft such that two rotation elements are selectively connected to the input shaft; a second planetary gear set including fourth, fifth, and sixth rotation elements and disposed on the output shaft such that two rotation elements are selectively connected to the input shaft, two rotation elements are connected to two rotation elements of the first planetary gear set, and one rotation element is directly connected to the output shaft; four transfer gears selectively meshing externally the fourth, fifth, and sixth rotation elements of the second planetary gear set with the input shaft and two rotation elements of the first planetary gear set; and six friction members including four clutches variably connecting two rotation elements of the first planetary gear set and two rotation elements of the second planetary gear set to the input shaft and two brakes variably connecting selected rotation elements among the rotation elements to a transmission housing.

The first planetary gear set may be a single pinion planetary gear set, wherein the first rotation element is a first sun gear, the second rotation element is a first planet carrier, and the third rotation element is a first ring gear.

The second planetary gear set may be a single pinion planetary gear set, wherein the fourth rotation element is a second sun gear, the fifth rotation element is a second planet carrier, and the sixth rotation element is a second ring gear.

The four transfer gears may include: a first transfer gear including a first transfer drive gear connected to the input shaft and a first transfer driven gear connected to the sixth rotation element; a second transfer gear including a second transfer drive gear connected to the third rotation element and a second transfer driven gear connected to the fifth rotation element; a third transfer gear including a third transfer drive gear connected to the first rotation element and a third transfer driven gear connected to the fourth rotation element; and a fourth transfer gear including a fourth transfer drive gear connected to the input shaft and a fourth transfer driven gear connected to the fourth rotation element.

In various aspects of the present invention, the six friction members may include: a first clutch disposed between the first transfer driven gear and the sixth rotation element; a second clutch disposed between the fourth transfer driven gear and the fourth rotation element; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

Each shift-speed may be achieved by operating two friction members among the six friction members, wherein a first forward speed is achieved by operating the first clutch and the first brake. a second forward speed is achieved by operating the first clutch and the second brake, a third forward speed is achieved by operating the first clutch and the second clutch, a fourth forward speed is achieved by operating the first clutch and the third clutch, a fifth forward speed is achieved by operating the first clutch and the fourth clutch, a sixth forward speed is achieved by operating the third clutch and the fourth clutch, a seventh forward speed is achieved by operating the second clutch and the fourth clutch, an eighth forward speed is achieved by operating the fourth clutch and the second brake, a first reverse speed is achieved by operating the second clutch and the first brake, and a second reverse speed is achieved by operating the third clutch and the first brake.

In various aspects of the present invention, the six friction members may include: a first clutch disposed between the input shaft and the first transfer drive gear; a second clutch disposed between the fourth transfer driven gear and the fourth rotation element; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

In various aspects of the present invention, the six friction members may include: a first clutch disposed between the first transfer driven gear and the sixth rotation element; a second clutch disposed between the input shaft and the fourth transfer drive gear; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

In various aspects of the present invention, the six friction members may include: a first clutch disposed between the input shaft and the first transfer drive gear; a second clutch disposed between the input shaft and the fourth transfer drive gear; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

A planetary gear train of an automatic transmission for a vehicle according to another aspect of the present invention may include: an input shaft receiving torque of an engine; an output shaft outputting changed torque; a first planetary gear set including a first sun gear of a first rotation element, a first planet carrier of a second rotation element, and a first ring gear of a third rotation element, and disposed on the input shaft, wherein the first and second rotation elements are selectively connected to the input shaft; a second planetary gear set including a second sun gear of a fourth rotation element, a second planet carrier of a fifth rotation element, and a second ring gear of a sixth rotation element, and disposed on the output shaft, wherein the fourth rotation element is selectively connected to the input shaft and fixedly connected to the first rotation element, the fifth rotation element is fixedly connected to the third rotation element and directly connected to the output shaft, and the sixth rotation element is selectively connected to the input shaft; four transfer gears selectively meshing externally the fourth, fifth, and sixth rotation elements with the input shaft and the first and third rotation elements; and six friction members including clutches selectively connecting the first, second, fourth, and sixth rotation elements to the input shaft and brakes selectively connecting the second and fourth rotation elements to a transmission housing.

Each of the first and second planetary gear sets may be a single pinion planetary gear set.

The four transfer gears may include: a first transfer gear including a first transfer drive gear connected to the input shaft and a first transfer driven gear connected to the sixth rotation element; a second transfer gear including a second transfer drive gear connected to the third rotation element and a second transfer driven gear connected to the fifth rotation element; a third transfer gear including a third transfer drive gear connected to the first rotation element and a third transfer driven gear connected to the fourth rotation element; and a fourth transfer gear including a fourth transfer drive gear connected to the input shaft and a fourth transfer driven gear connected to the fourth rotation element.

In various aspects of the present invention, the six friction members may include: a first clutch disposed between the first transfer driven gear and the sixth rotation element; a second clutch disposed between the fourth transfer driven gear and the fourth rotation element; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

Each shift-speed may be achieved by operating two friction members among the six friction members, wherein a first forward speed is achieved by operating the first clutch and the first brake. a second forward speed is achieved by operating the first clutch and the second brake, a third forward speed is achieved by operating the first clutch and the second clutch, a fourth forward speed is achieved by operating the first clutch and the third clutch, a fifth forward speed is achieved by operating the first clutch and the fourth clutch, a sixth forward speed is achieved by operating the third clutch and the fourth clutch, a seventh forward speed is achieved by operating the second clutch and the fourth clutch, an eighth forward speed is achieved by operating the fourth clutch and the second brake, a first reverse speed is achieved by operating the second clutch and the first brake, and a second reverse speed is achieved by operating the third clutch and the first brake.

In various aspects of the present invention, the six friction members may include: a first clutch disposed between the input shaft and the first transfer drive gear; a second clutch disposed between the fourth transfer driven gear and the fourth rotation element; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

In various aspects of the present invention, the six friction members may include: a first clutch disposed between the first transfer driven gear and the sixth rotation element; a second clutch disposed between the input shaft and the fourth transfer drive gear; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

In various aspects of the present invention, the six friction members may include: a first clutch disposed between the input shaft and the first transfer drive gear; a second clutch disposed between the input shaft and the fourth transfer drive gear; a third clutch disposed between the input shaft and the first rotation element; a fourth clutch disposed between the input shaft and the second rotation element; a first brake disposed between the second rotation element and the transmission housing; and a second brake disposed between the fourth rotation element and the transmission housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary planetary gear train according to the present invention.

FIG. 2 is an operational chart of friction members at each shift-speed applied to the planetary gear train of FIG. 1.

FIG. 3A is a lever diagram of a planetary gear train of FIG. 1 at the first forward speed.

FIG. 3B is a lever diagram of a planetary gear train of FIG. 1 at the second forward speed.

FIG. 3C is a lever diagram of a planetary gear train of FIG. 1 at the third forward speed.

FIG. 3D is a lever diagram of a planetary gear train of FIG. 1 at the fourth forward speed.

FIG. 3E is a lever diagram of a planetary gear train of FIG. 1 at the fifth forward speed.

FIG. 3F is a lever diagram of a planetary gear train of FIG. 1 at the sixth forward speed.

FIG. 3G is a lever diagram of a planetary gear train of FIG. 1 at the seventh forward speed.

FIG. 3H is a lever diagram of a planetary gear train of FIG. 1 at the eighth forward speed.

FIG. 3I is a lever diagram of a planetary gear train of FIG. 1 at the first reverse speed.

FIG. 3J is a lever diagram of a planetary gear train of FIG. 1 at the second reverse speed.

FIG. 4 is a schematic diagram of an exemplary planetary gear train according to the present invention.

FIG. 5 is a schematic diagram of an exemplary planetary gear train according to the present invention.

FIG. 6 is a schematic diagram of an exemplary planetary gear train according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present exemplary embodiments will be omitted, and the same constituent elements are denoted by the same reference numerals in this specification.

In the detailed description, ordinal numbers are used for distinguishing constituent elements having the same terms, and have no specific meanings.

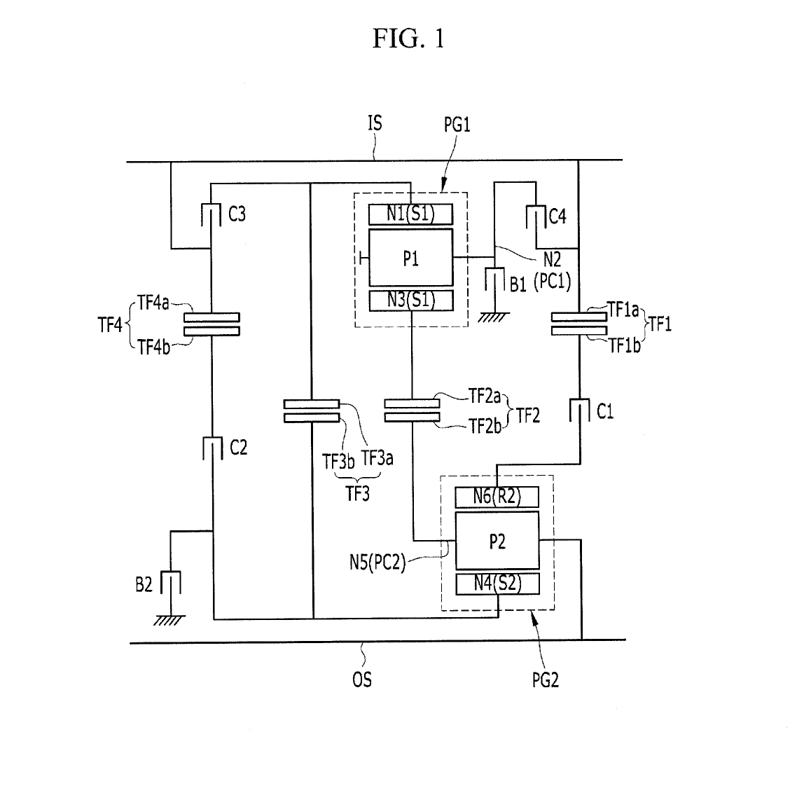

FIG. 1 is a schematic diagram of a planetary gear train according to various embodiments of the present invention. Referring to FIG. 1, a planetary gear train may include a first planetary gear set PG1 disposed on an input shaft IS, a second planetary gear set PG2 disposed on an output shaft OS disposed in parallel with the input shaft IS, friction members including four clutches C1, C2, C3, and C4 and two brakes B1 and B2.

The first planetary gear set PG1 is disposed on the input shaft IS, and the second planetary gear set PG2 is disposed on the output shaft OS disposed in parallel with the input shaft IS.

Therefore, torque input to the input shaft IS is converted into eight forward speeds and two reverse speeds by operations of the first and second planetary gear sets PG1 and PG2, and then is output through the output shaft OS.

The input shaft IS is an input member, and torque from a crankshaft of the engine is changed through a torque converter and is input to the input shaft IS.

The output shaft OS is an output member and delivers driving torque so as to run driving wheels through a differential apparatus.

The first planetary gear set PG1 is a single pinion planetary gear set, and includes a first rotation element N1 of a first sun gear S1, a second rotation element N2 of a first planet carrier PC1 rotatably supporting a first pinion P1 externally meshed with the first sun gear S1, and a third rotation element N3 of a first ring gear R1 internally meshed with the first pinion P1.

The second planetary gear set PG2 is a single pinion planetary gear set, and includes a fourth rotation element N4 of a second sun gear S2, a fifth rotation element N5 of a second planet carrier PC2 rotatably supporting a second pinion P2 externally meshed with the second sun gear S2, and a sixth rotation element N6 of a second ring gear R2 internally meshed with the second pinion P2.

Two rotation elements of the first planetary gear set PG1 are selectively connected to the input shaft IS, three rotation elements of the second planetary gear set PG2 are connected to the input shaft IS and two rotation elements of the first planetary gear set PG1 through first, second, third, and fourth transfer gears TF1, TF2, TF3, and TF4, and any one rotation element of the second planetary gear set PG2 is directly connected to the output shaft OS.

The first, second, third, and fourth transfer gears TF1, TF2, TF3, and TF4 respectively have first, second, third, and fourth transfer drive gears TF1a, TF2a, TF3a, and TF4a and first, second, third, and fourth transfer driven gears TF1b, TF2b, TF3b, and TF4b externally meshed with each other.

The first transfer gear TF1 connects the input shaft IS with the sixth rotation element N6.

The second transfer gear TF2 connects the third rotation element N3 with the fifth rotation element N5.

The third transfer gear TF3 connects the first rotation element N1 with the fourth rotation element N4.

The fourth transfer gear TF4 connects the input shaft IS with the fourth rotation element N4.

The input shaft IS or rotation elements of the first planetary gear set PG1 and rotation elements of the second planetary gear set PG2 connected by the first, second, third, and fourth transfer gears TF1, TF2, TF3, and TF4 are rotated in opposite directions to each other.

Gear ratios of the first, second, third, and fourth transfer gears may be set by a person skilled in the art.

In addition, four clutches C1, C2, C3, and C4 variably connecting the input shaft IS with the selected rotation elements and two brakes B1 and B2 variably connecting the selected rotation elements with a transmission housing H are disposed as follows.

A first clutch C1 is disposed between the first transfer driven gear TF1b and the sixth rotation element N6.

A second clutch C2 is disposed between the fourth transfer driven gear TF4b and the fourth rotation element N4.

A third clutch C3 is disposed between the input shaft IS and the first rotation element N1.

A fourth clutch C4 is disposed between the input shaft IS and the second rotation element N2.

A first brake B1 is disposed between the second rotation element N2 and the transmission housing H.

A second brake B2 is disposed between the fourth rotation element N4 and the transmission housing H.

In addition, the friction members consisting of the first, second, third, and fourth clutches C1, C2, C3, and C4 and the first and second brakes B1 and B2 are conventional multi-plate friction elements of wet type that are operated by hydraulic pressure.

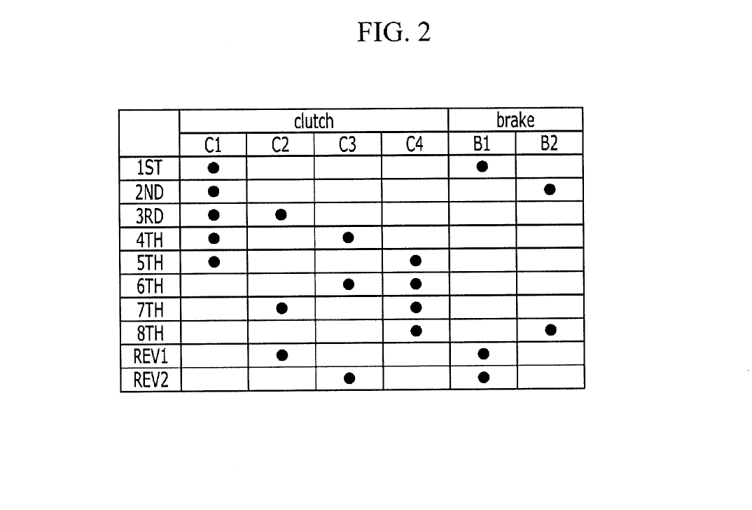

FIG. 2 is an operational chart of friction members at each shift-speed applied to a planetary gear train according to various embodiments of the present invention.

As shown in FIG. 2, two friction members are operated at each shift-speed in the planetary gear train according to various embodiments of the present invention.

A first forward speed 1ST is achieved by operating the first clutch C1 and the first brake B1.

A second forward speed 2ND is achieved by operating the first clutch C1 and the second brake B2.

A third forward speed 3RD is achieved by operating the first clutch C1 and the second clutch C2.

A fourth forward speed 4TH is achieved by operating the first clutch C1 and the third clutch C3.

A fifth forward speed 5TH is achieved by operating the first clutch C1 and the fourth clutch C4.

A sixth forward speed 6TH is achieved by operating the third clutch C3 and the fourth clutch C4.

A seventh forward speed 7TH is achieved by operating the second clutch C2 and the fourth clutch C4.

An eighth forward speed 8TH is achieved by operating the fourth clutch C4 and the second brake B2.

A first reverse speed REV1 is achieved by operating the second clutch C2 and the first brake B1.

A second reverse speed REV2 is achieved by operating the third clutch C3 and the first brake B1.

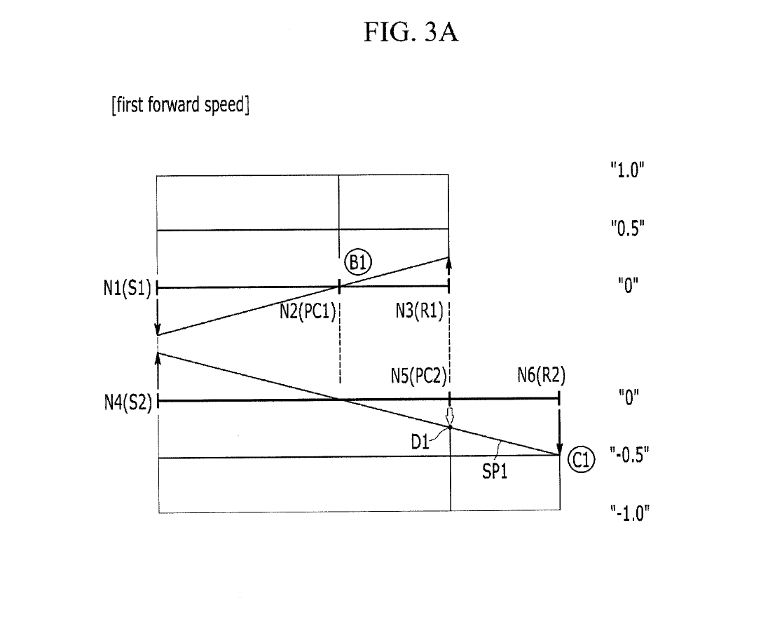

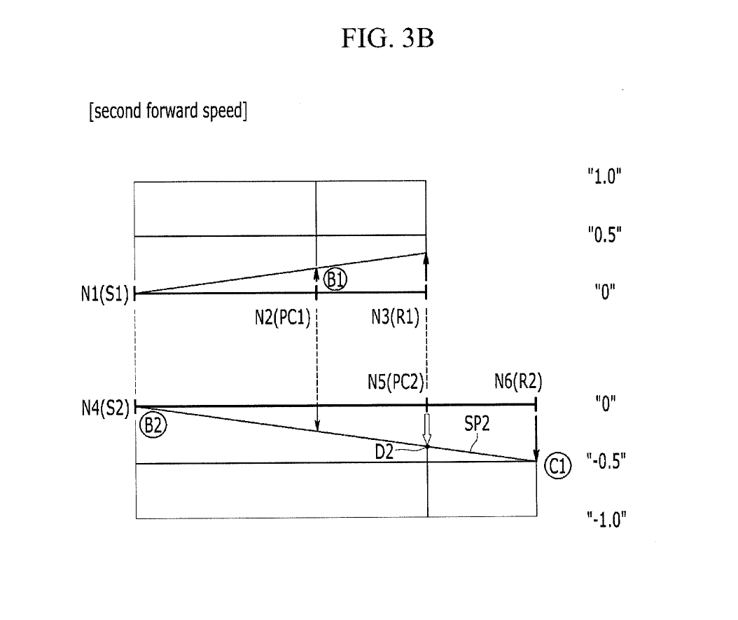

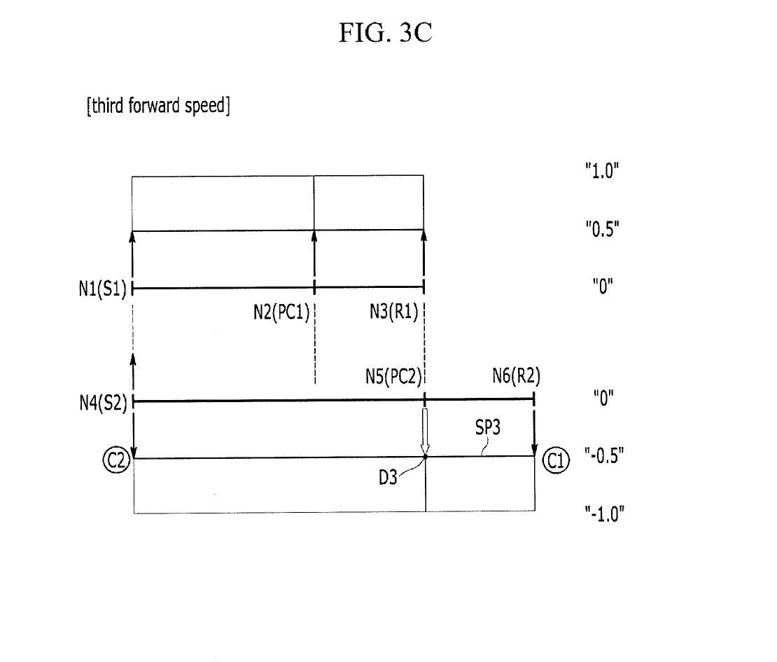

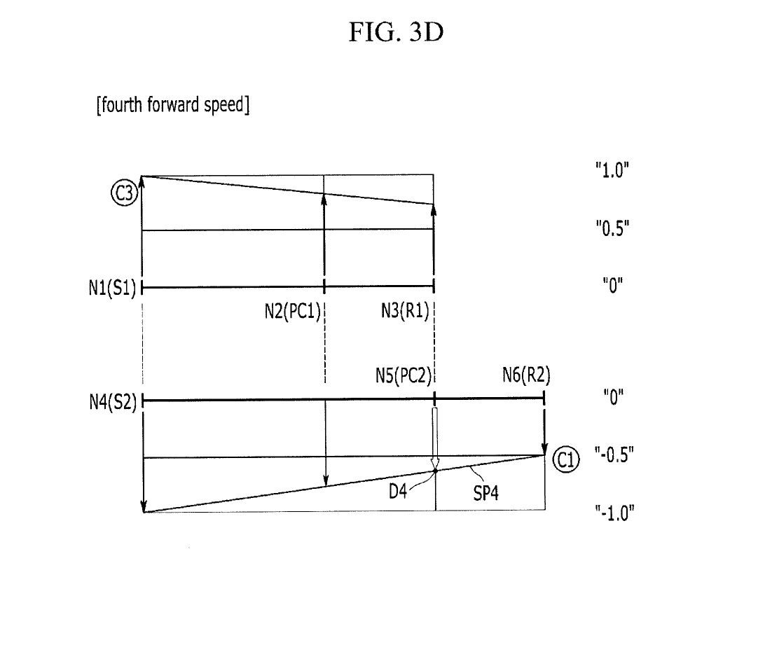

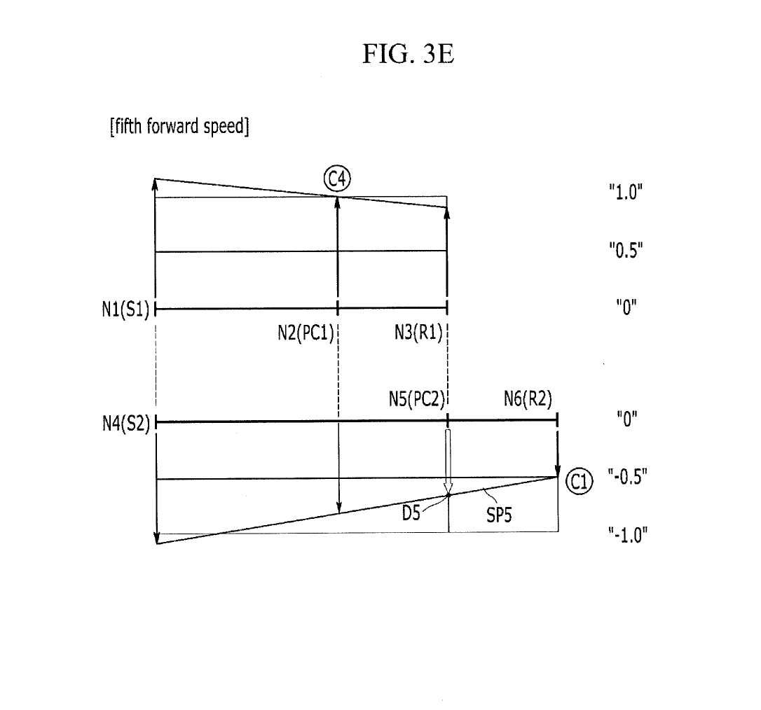

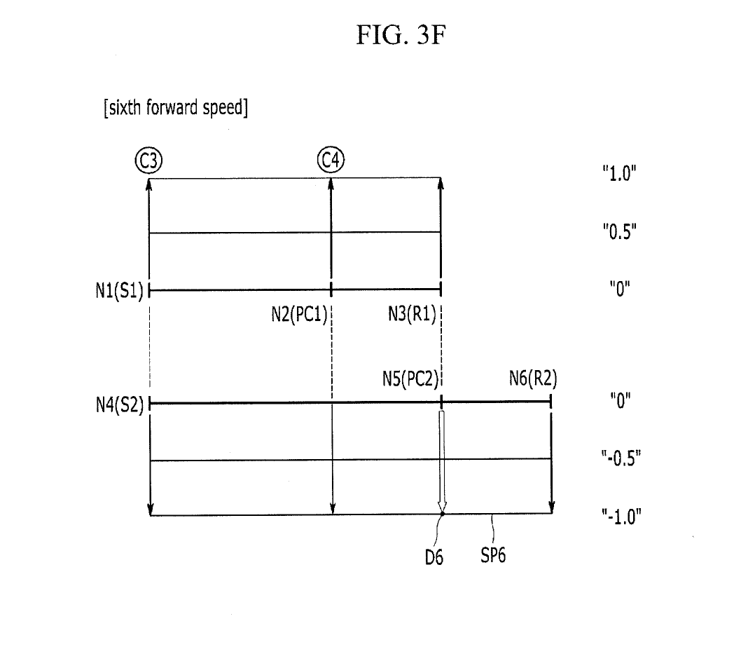

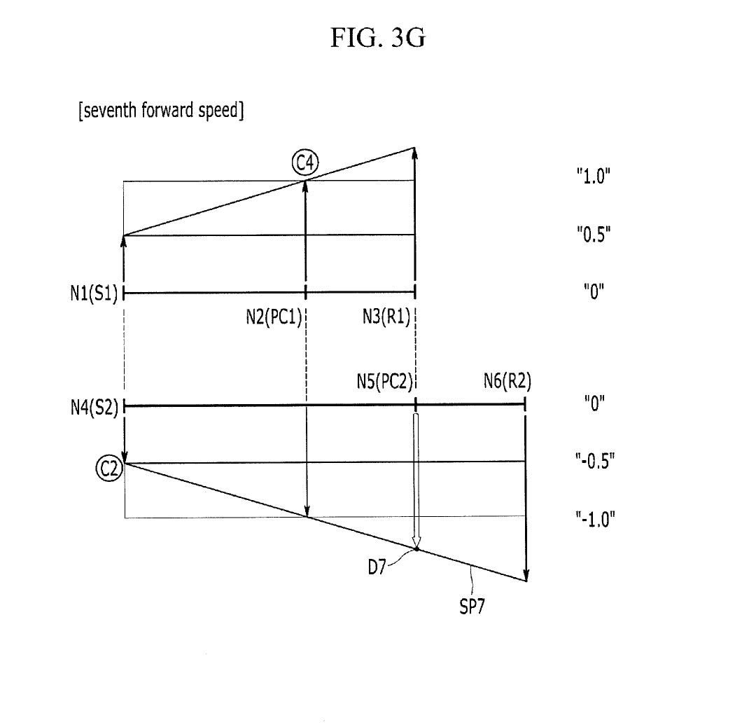

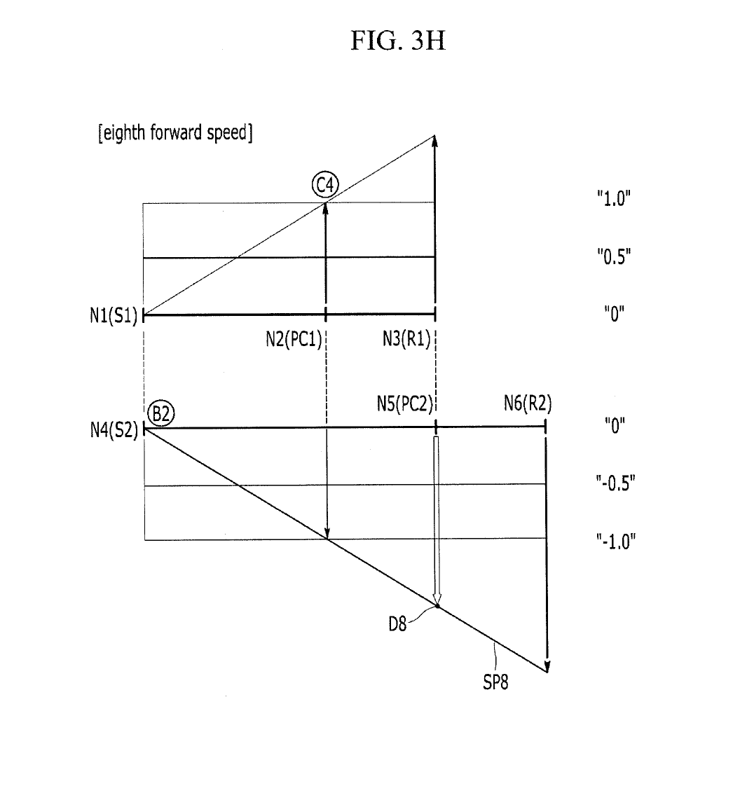

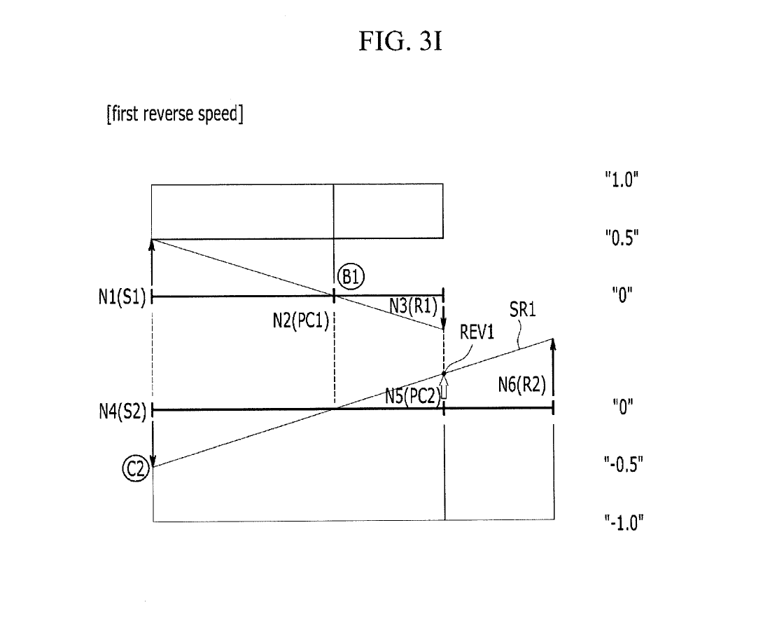

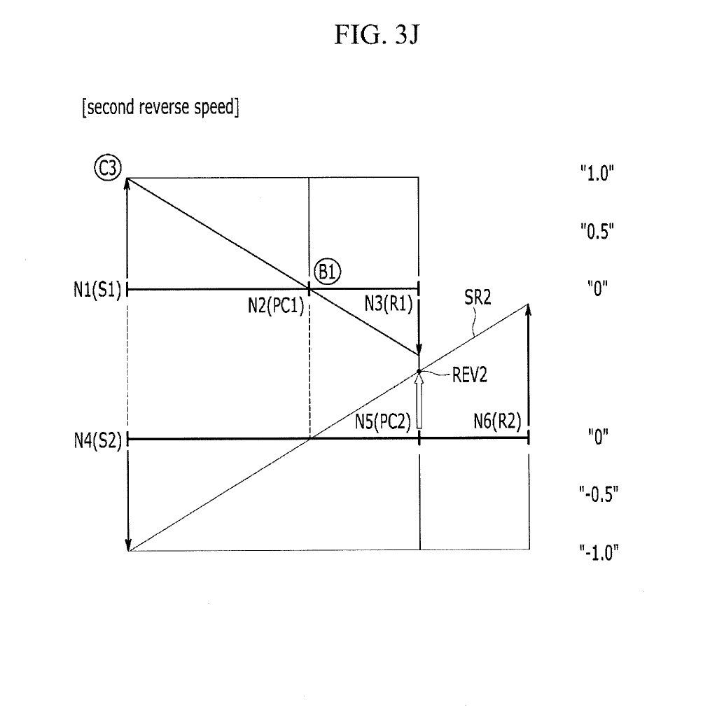

FIG. 3A to FIG. 3J are lever diagrams of the planetary gear train at each shift-speed according to various embodiments of the present invention, and illustrate shift processes of the planetary gear train according to various embodiments of the present invention by lever analysis method.

Referring to FIG. 3A to FIG. 3J, three vertical lines of the first planetary gear set PG1 are set as the first, second, and third rotation elements N1, N2, and N3 from the left to the right, a lower horizontal line represents a rotation speed of “0”, a middle horizontal line represents a rotation speed of “0.5”, and an upper horizontal line represents a rotation speed of “1.0”, that is the same rotational speed as the input shaft IS.

Three vertical lines of the second planetary gear set PG2 are set as the fourth, fifth, and sixth rotation elements N4, N5, and N6 from the left to the right, and third rotation elements N1, N2, and N3 from the left to the right, a lower horizontal line represents a rotation speed of “0”, a middle horizontal line represents a rotation speed of “−0.5”, and an upper horizontal line represents a rotation speed of “−1.0”, that is the same rotational speed as the input shaft IS.

“−” means that rotational elements is rotated in an opposite direction of a rotational direction of the engine. Since the input shaft IS and the first planetary gear set PG1 are externally meshed with the second planetary gear set PG2 through the first, second, third, and fourth transfer gears TF1, TF2, TF3, and TF4 without an idling gear, each rotation element of the second planetary gear set PG2 rotates in an opposite direction. Therefore, “−” is given to each rotation element of the second planetary gear set PG2.

In addition, distances between the vertical lines of the first and second planetary gear sets PG1 and PG2 are set according to each gear ratio (teeth number of a sun gear/teeth number of a ring gear).

Hereinafter, referring to FIG. 2 and FIG. 3A to FIG. 3J, the shift processes of the planetary gear train according to various embodiments of the present invention will be described in detail.

First Forward Speed

Referring to FIG. 2, the first clutch C1 and the first brake B1 are operated at the first forward speed 1ST.

As shown in FIG. 3A, the rotation speed of “−0.5” is input to the sixth rotation element N6 of the second planetary gear set PG2 by an operation of the first clutch C1, and the second rotation element N2 of the first planetary gear set PG1 is operated as a fixed element by an operation of the first brake B1.

Therefore, the rotation elements of the second planetary gear set PG2 form a first shift line SP1 by operations of the first and second planetary gear sets PG1 and PG2 such that D1 is output through the fifth rotation element N5 that is an output element.

At this time, the rotation elements of the first planetary gear set PG1 rotate in opposite directions of the rotation elements of the second planetary gear set PG2 externally meshed thereto.

Second Forward Speed

The first brake B1 that was operated at the first forward speed 1ST is released and the second brake B2 is operated at the second forward speed 2ND.

As shown in FIG. 3B, the rotation speed of “−0.5” is input to the sixth rotation element N6 of the second planetary gear set PG2 by an operation of the first clutch C1, and the fourth rotation element N4 of the second planetary gear set PG2 is operated as a fixed element by operation of the second brake B2.

Therefore, the rotation elements of the second planetary gear set PG2 form a second shift line SP2 such that D2 is output through the fifth rotation element N5 that is the output element.

At this time, the rotation elements of the first planetary gear set PG1 rotate in opposite directions of the rotation elements of the second planetary gear set PG2 externally meshed thereto.

Third Forward Speed

The second brake B2 that was operated at the second forward speed 2ND is released and the second clutch C2 is operated at the third forward speed 3RD.

As shown in FIG. 3C, the rotation speed of “−0.5” is simultaneously input to the fourth and sixth rotation elements N4 and N6 of the second planetary gear set PG2 by operations of the first and second clutches C1 and C2, and the second planetary gear set PG2 becomes a direct-coupling state. Therefore, the rotation elements of the second planetary gear set PG2 forms a third shift line SP3 such that D3 is output through the fifth rotation element N5 that is the output element.

At this time, the first planetary gear set PG1 becomes a direct-coupling state, and the rotation elements of the first planetary gear set PG1 rotate in opposite directions of the rotation elements of the second planetary gear set PG2 externally meshed thereto.

Fourth Forward Speed

The second clutch C2 that was operated at the third forward speed 3RD is released and the third clutch C3 is operated at the fourth forward speed 4TH.

As shown in FIG. 3D, the rotation speed of “−0.5” is input to the sixth rotation element N6 of the second planetary gear set PG2 by an operation of the first clutch C1, and a rotation speed of “−1.0” is input to the fourth rotation element N4 of the second planetary gear set PG2 by operation of the third clutch C3.

Therefore, the rotation elements of the second planetary gear set PG2 form a fourth shift line SP4 such that D4 is output through the fifth rotation element N5 that is the output element.

At this time, the rotation elements of the first planetary gear set PG1 rotate in opposite directions of the rotation elements of the second planetary gear set PG2 externally meshed thereto.

Fifth Forward Speed

The third clutch C3 that was operated at the fourth forward speed 4TH is released and the fourth clutch C4 is operated at the fifth forward speed 5TH.

As shown in FIG. 3E, the rotation speed of “−0.5” is input to the sixth rotation element N6 by operation of the first clutch C1, and a rotation speed of “1.0” is input to the second rotation element N2 by operation of the fourth clutch C4.

Therefore, the rotation elements of the second planetary gear set PG2 form a fifth shift line SP5 by operations of the first and second planetary gear sets PG1 and PG2 such that D5 is output through the fifth rotation element N5 that is the output element.

At this time, the rotation elements of the first planetary gear set PG1 rotate in opposite directions of the rotation elements of the second planetary gear set PG2 externally meshed thereto.

Sixth Forward Speed

The first clutch C1 that was operated at the fifth forward speed 5TH is released and the third clutch C3 is operated at the sixth forward speed 6TH.

As shown in FIG. 3F, since the rotation speed of “1.0” is input simultaneously to the first and second rotation elements N1 and N2 of the first planetary gear set PG1 by operations of the third and fourth clutches C3 and C4, the first and second planetary gear sets PG1 and PG2 become direct-coupling states. Therefore, the rotation elements of the second planetary gear set PG2 form a sixth shift line SP6 such that D6 is output through the fifth rotation element N5 that is the output element.

Seventh Forward Speed

The third clutch C3 that was operated at the sixth forward speed 6TH is released and the second clutch C2 is operated at the seventh forward speed 7TH.

As shown in FIG. 3G, the rotation speed of “−0.5” is input to the fourth rotation element N4 by operation of the second clutch C2, and the rotation speed of “1.0” is input to the second rotation element N2 by operation of the fourth clutch C4.

Therefore, the rotation elements of the second planetary gear set PG2 form a seventh shift line SP7 by operations of the first and second planetary gear sets PG1 and PG2 such that D7 is output through the fifth rotation element N5 that is the output element.

Eighth Forward Speed

The second clutch C2 that was operated at the seventh forward speed 7TH is released and the second brake B2 is operated at the eighth forward speed 8TH.

As shown in FIG. 3H, the rotation speed of “1.0” is input to the second rotation element N2 by operation of the fourth clutch C4, and the first and fourth rotation elements N1 and N4 are operated as the fixed elements by operation of the second brake B2.

Therefore, the rotation elements of the second planetary gear set PG2 form an eighth shift line SP8 such that D8 is output through the fifth rotation element N5 that is the output element.

First Reverse Speed

As shown in FIG. 2, the second clutch C2 and the first brake B1 are operated at the first reverse speed REV1.

As shown in FIG. 3I, the rotation speed of “0.5” is input to the first rotation element N1 by operation of the second clutch C2, and the second rotation element N2 is operated as the fixed element by operation of the first brake B1.

Therefore, the rotation elements of the second planetary gear set PG2 form a first reverse shift line SR1 by operations of the first and second planetary gear sets PG1 and PG2 such that REV1 is output through the fifth rotation element N5 that is the output element.

Second Reverse Speed

As shown in FIG. 2, the second clutch C2 that was operated at the first reverse speed REV1 is released and the third clutch C3 is operated at the second reverse speed REV2.

As shown in FIG. 3J, the rotation speed of “1.0” is input to the first rotation element N1 by operation of the third clutch C3, and the second rotation element N2 is operated as the fixed element by operation of the first brake B1.

Therefore, the rotation elements of the second planetary gear set PG2 form a second reverse shift line SR2 by operations of the first and second planetary gear sets PG1 and PG2 such that REV2 is output through the fifth rotation element N5 that is the output element.

As described above, the planetary gear train according to various embodiments of the present invention can achieve the eighth forward speeds and two reverse speeds by combining two planetary gear sets PG1 and PG2 that are simple planetary gear sets, four externally-meshed gears TF1, TF2, TF3, and TF4, and six friction members C1, C2, C3, C4, B1, and B2.

In addition, two friction members are operated at each shift-speed, and one friction member is released and another friction member is operated so as to shift to a neighboring shift-speed. Therefore, shift control condition is fully satisfied.

In addition, since step ratios between the neighboring shift-speeds are controlled to be suitable, power delivery performance and fuel economy may be improved.

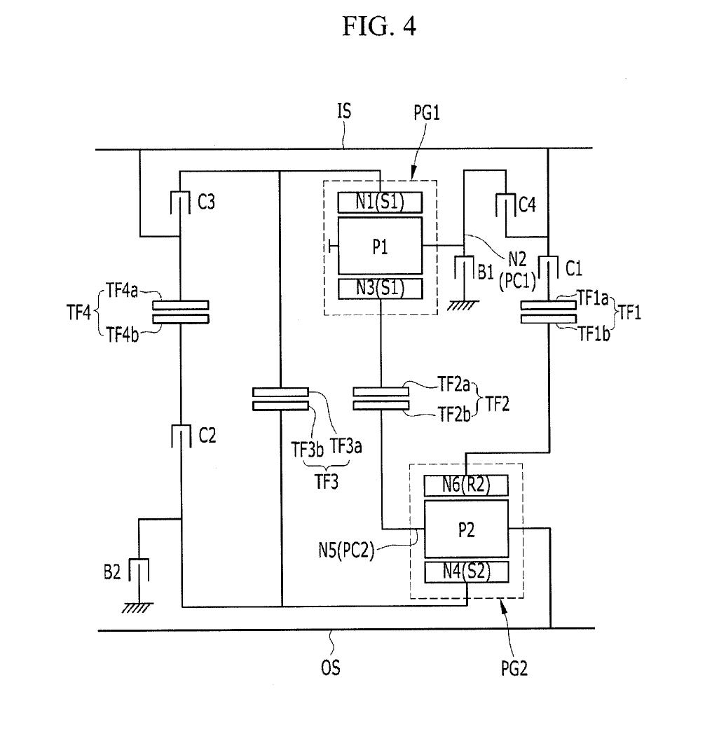

FIG. 4 is a schematic diagram of a planetary gear train according to various embodiments of the present invention. Referring to FIG. 4, the illustrated embodiment, as compared with the above embodiments, has the first clutch C1 disposed between the input shaft IS and the first transfer gear TF1. Since components and functions of the illustrated embodiment are the same as those of the above embodiments except a position of the first clutch C1, detailed description thereof will be omitted.

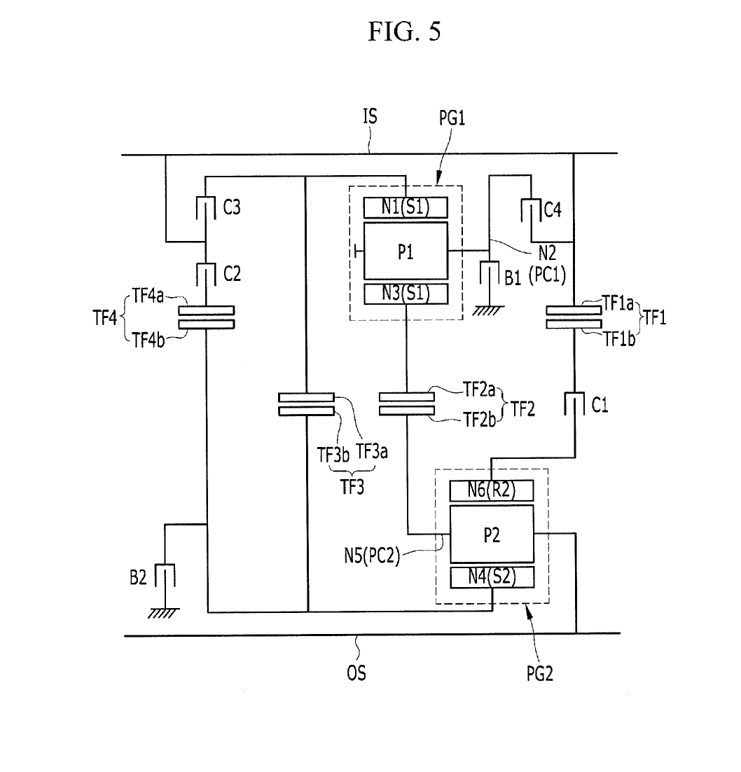

FIG. 5 is a schematic diagram of a planetary gear train according to various embodiments of the present invention. Referring to FIG. 5, the illustrated embodiment, as compared with the above embodiments, has the second clutch C2 disposed between the input shaft IS and the fourth transfer gear TF4. Since components and functions of the illustrated embodiment are the same as those of the above embodiments except a position of the second clutch C2, detailed description thereof will be omitted.

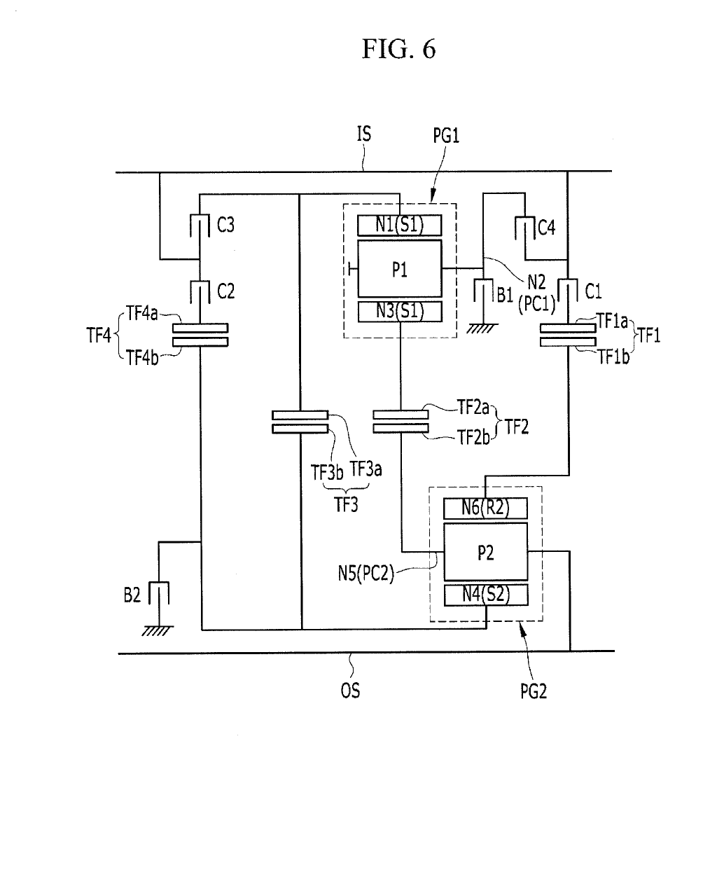

FIG. 6 is a schematic diagram of a planetary gear train according to various embodiments of the present invention. Referring to FIG. 6, the illustrated embodiment, as compared with the above embodiments, has the first clutch C1 disposed between the input shaft IS and the first transfer gear TF1 and the second clutch C2 disposed between the input shaft IS and the fourth transfer gear TF4. Since components and functions of the illustrated embodiment are the same as those of the above embodiments except positions of the first and second clutches C1 and C2, detailed description will be omitted.

Various embodiments of the present invention can achieve the eighth forward speeds and two reverse speeds by combining two planetary gear sets that are simple planetary gear sets, four externally-meshed gears, and six friction members.

In addition, two friction members are operated at each shift-speed, and one friction member is released and another friction member is operated so as to shift to a neighboring shift-speed. Therefore, shift control condition is fully satisfied.

In addition, since step ratios between the neighboring shift-speeds are controlled to be suitable, power delivery performance and fuel economy may be improved.

For convenience in explanation and accurate definition in the appended claims, the terms upper and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A planetary gear train of an automatic transmission for a vehicle, comprising:
an input shaft receiving torque of an engine;
an output shaft outputting changed torque;
a first planetary gear set including first, second, and third rotation elements and disposed on the input shaft such that two rotation elements are selectively connected to the input shaft;
a second planetary gear set including fourth, fifth, and sixth rotation elements and disposed on the output shaft such that two rotation elements are selectively connected to the input shaft, two rotation elements are connected to two rotation elements of the first planetary gear set, and one rotation element is directly connected to the output shaft;
four transfer gears selectively meshing externally the fourth, fifth, and sixth rotation elements of the second planetary gear set with the input shaft and two rotation elements of the first planetary gear set; and
six friction members including four clutches variably connecting two rotation elements of the first planetary gear set and two rotation elements of the second planetary gear set to the input shaft and two brakes variably connecting selected rotation elements among the rotation elements to a transmission housing.

2. The planetary gear train of claim 1, wherein the first planetary gear set is a single pinion planetary gear set, wherein the first rotation element is a first sun gear, the second rotation element is a first planet carrier, and the third rotation element is a first ring gear, and
the second planetary gear set is a single pinion planetary gear set, wherein the fourth rotation element is a second sun gear, the fifth rotation element is a second planet carrier, and the sixth rotation element is a second ring gear.

3. The planetary gear train of claim 1, wherein the four transfer gears comprise:
a first transfer gear including a first transfer drive gear connected to the input shaft and a first transfer driven gear connected to the sixth rotation element;
a second transfer gear including a second transfer drive gear connected to the third rotation element and a second transfer driven gear connected to the fifth rotation element;
a third transfer gear including a third transfer drive gear connected to the first rotation element and a third transfer driven gear connected to the fourth rotation element; and
a fourth transfer gear including a fourth transfer drive gear connected to the input shaft and a fourth transfer driven gear connected to the fourth rotation element.

4. The planetary gear train of claim 3, wherein the six friction members comprise:
a first clutch disposed between the first transfer driven gear and the sixth rotation element;
a second clutch disposed between the fourth transfer driven gear and the fourth rotation element;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

5. The planetary gear train of claim 4, wherein each shift-speed is achieved by operating two friction members among the six friction members,
a first forward speed is achieved by operating the first clutch and the first brake.
a second forward speed is achieved by operating the first clutch and the second brake,
a third forward speed is achieved by operating the first clutch and the second clutch,
a fourth forward speed is achieved by operating the first clutch and the third clutch,
a fifth forward speed is achieved by operating the first clutch and the fourth clutch,
a sixth forward speed is achieved by operating the third clutch and the fourth clutch,
a seventh forward speed is achieved by operating the second clutch and the fourth clutch,
an eighth forward speed is achieved by operating the fourth clutch and the second brake,
a first reverse speed is achieved by operating the second clutch and the first brake, and
a second reverse speed is achieved by operating the third clutch and the first brake.

6. The planetary gear train of claim 3, wherein the six friction member comprise:
a first clutch disposed between the input shaft and the first transfer drive gear;
a second clutch disposed between the fourth transfer driven gear and the fourth rotation element;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

7. The planetary gear train of claim 3, wherein the six friction member comprise:
a first clutch disposed between the first transfer driven gear and the sixth rotation element;
a second clutch disposed between the input shaft and the fourth transfer drive gear;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

8. The planetary gear train of claim 3, wherein the six friction member comprise:
a first clutch disposed between the input shaft and the first transfer drive gear;
a second clutch disposed between the input shaft and the fourth transfer drive gear;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

9. A planetary gear train of an automatic transmission for a vehicle, comprising:
an input shaft receiving torque of an engine;
an output shaft outputting changed torque;
a first planetary gear set including a first sun gear of a first rotation element, a first planet carrier of a second rotation element, and a first ring gear of a third rotation element, and disposed on the input shaft, wherein the first and second rotation elements are selectively connected to the input shaft;
a second planetary gear set including a second sun gear of a fourth rotation element, a second planet carrier of a fifth rotation element, and a second ring gear of a sixth rotation element, and disposed on the output shaft, wherein the fourth rotation element is selectively connected to the input shaft and fixedly connected to the first rotation element, the fifth rotation element is fixedly connected to the third rotation element and directly connected to the output shaft, and the sixth rotation element is selectively connected to the input shaft;
four transfer gears selectively meshing externally the fourth, fifth, and sixth rotation elements with the input shaft and the first and third rotation elements; and
six friction members including clutches selectively connecting the first, second, fourth, and sixth rotation elements to the input shaft and brakes selectively connecting the second and fourth rotation elements to a transmission housing.

10. The planetary gear train of claim 9, wherein each of the first and second planetary gear sets is a single pinion planetary gear set.

11. The planetary gear train of claim 9, wherein the four transfer gears comprise:
a first transfer gear including a first transfer drive gear connected to the input shaft and a first transfer driven gear connected to the sixth rotation element;
a second transfer gear including a second transfer drive gear connected to the third rotation element and a second transfer driven gear connected to the fifth rotation element;
a third transfer gear including a third transfer drive gear connected to the first rotation element and a third transfer driven gear connected to the fourth rotation element; and
a fourth transfer gear including a fourth transfer drive gear connected to the input shaft and a fourth transfer driven gear connected to the fourth rotation element.

12. The planetary gear train of claim 11, wherein the six friction members comprise:
a first clutch disposed between the first transfer driven gear and the sixth rotation element;
a second clutch disposed between the fourth transfer driven gear and the fourth rotation element;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

13. The planetary gear train of claim 12, wherein each shift-speed is achieved by operating two friction members among the six friction members,
a first forward speed is achieved by operating the first clutch and the first brake.
a second forward speed is achieved by operating the first clutch and the second brake,
a third forward speed is achieved by operating the first clutch and the second clutch,
a fourth forward speed is achieved by operating the first clutch and the third clutch,
a fifth forward speed is achieved by operating the first clutch and the fourth clutch,
a sixth forward speed is achieved by operating the third clutch and the fourth clutch,
a seventh forward speed is achieved by operating the second clutch and the fourth clutch,
an eighth forward speed is achieved by operating the fourth clutch and the second brake,
a first reverse speed is achieved by operating the second clutch and the first brake, and
a second reverse speed is achieved by operating the third clutch and the first brake.

14. The planetary gear train of claim 11, wherein the six friction member comprise:
a first clutch disposed between the input shaft and the first transfer drive gear;
a second clutch disposed between the fourth transfer driven gear and the fourth rotation element;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

15. The planetary gear train of claim 11, wherein the six friction member comprise:
a first clutch disposed between the first transfer driven gear and the sixth rotation element;
a second clutch disposed between the input shaft and the fourth transfer drive gear;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.

16. The planetary gear train of claim 11, wherein the six friction member comprise:
a first clutch disposed between the input shaft and the first transfer drive gear;
a second clutch disposed between the input shaft and the fourth transfer drive gear;
a third clutch disposed between the input shaft and the first rotation element;
a fourth clutch disposed between the input shaft and the second rotation element;
a first brake disposed between the second rotation element and the transmission housing; and
a second brake disposed between the fourth rotation element and the transmission housing.
